(19) United States
(12) Patent Application Publication
(10) Pub. No.: US 2025/0111228 A1
(43) Pub. Date: Apr. 3, 2025

(54) Systems and Methods for Improved Development and Implementation of Large Deep Neural Networks

(71) Applicant: The Trustees of Columbia university in the City of New York, New York, NY (US)

(72) Inventor: Venkat VENKATASUBRAMANIAN, New York, NY (US)

(73) Assignee: The Trustees of Columbia university in the City of New York, New York, NY (US)

(21) Appl. No.: 18/902,095

(22) Filed: Sep. 30, 2024

Related U.S. Application Data
(60) Provisional application No. 63/569,658, filed on Mar. 25, 2024.
(60) Provisional application No. 63/541,349, filed on Sep. 29, 2023.

(51) Int. Cl. G06N 3/08

(52) U.S. Cl. CPC G06N 3/08

(57) ABSTRACT

Disclosed are systems, methods, and other implementations, including a method for configuring a machine learning (ML) system. The method includes determining for a layer, l, of the ML system sets of parameters defining one or more statistical distribution models (e.g., lognormal) used for directing the ML system to an optimized configuration. The layer is connected to one or more other layers through weighted connected, and includes configurable ML elements (e.g., neurons) that can be tuned. The method also includes adjusting one or more of, a) weights of the weighted connections of the layer according to parameters defining a first distribution model, b) adjustable parameters defining the first statistical distribution model, c) ML element parameters, defining operations of at least some of the configurable ML elements, according to parameters defining a second distribution model, and/or d) adjustable parameters defining the second distribution model.

### CROSS-REFERENCE TO RELATED APPLICATIONS

This application claims priority to, and the benefit of, U.S. Provisional Application No. 63/541,349, entitled “Systems and Methods for Improving the Design and Development of Large Deep Neural Networks” and filed Sep. 29, 2023, and U.S. Provisional Application No. 63/569,658, entitled “Systems and Methods for Improving the Design and Development of Large Deep Neural Networks” and filed Mar. 25, 2024, the contents of all of which are incorporated herein by reference in their entireties.

### BACKGROUND

For over forty years, the prevailing theory of neural networks has been the physics-based approach, where one defines an “energy” function that is minimized as the network learns the input-output patterns. Canonical examples of this approach are the Hopfield network and the Boltzmann machine and their variants. On the other hand, the practice of neural network training and deployment is dominated by the backpropagation procedure combined with gradient descent. However, these dominant frameworks are unable to answer some fundamental questions about deep neural networks.

### SUMMARY

The present disclosure discussed proposed improved approaches for efficiently configuring machine learning systems, such as systems based on neural network implementations, based on a game-theoretic framework, called statistical teleodynamics. Robust implementations of a machine learning system/network involves computational benefit-cost trade-offs that are not adequately captured by physics-inspired models. These trade-offs occur as neurons and connections compete to increase their effective utilities under resource constraints during training. In a fully trained network, this results in a state of arbitrage equilibrium, where all neurons in a given layer have the same effective utility, and all connections to a given layer have the same effective utility. The equilibrium is characterized by the emergence of two lognormal distributions of connection weights and neuronal output as a universal microstructure of large deep neural networks. Under the proposed approaches, machine learning systems can be configured in an efficient manner (e.g., more quickly and/or with a reduced computational effort) to optimize weights and configurable ML elements (nodes) according to appropriate or desired statistical distribution models, including lognormal distributions.

Thus, in some variations, a method for configuring a machine learning system is disclosed. The method includes determining for a layer, l, of the machine learning (ML) system with multiple layers, L, sets of parameters defining one or more statistical distribution models used for directing the ML system to an optimized configuration, with each of the multiple layers being connected to one or more other layers through weighted connections, and with each layer including respective configurable ML elements to perform adjustable operations on weighted data received through the weighted connections. The method further includes adjusting one or more of:
at least one of, a) weights of the weighted connections of the layer according to a first set of parameters defining a first statistical distribution model to control characteristics of the weights, and/or b) adjustable first parameters of the first set of parameters defining the first statistical distribution model; and/or
at least one of: c) ML element parameters defining operations of at least some of the configurable ML elements of the layer according to a second set of parameters, defining a second statistical model, to control operational characteristics of the ML elements, and/or d) adjustable second parameters of the second set of parameters defining the second statistical distribution model.

Embodiments of the method may include at least some of the features described in the present disclosure, including one or more of the following features.

The ML system may be a neural network system, and the first statistical distribution model may be a first lognormal distribution defined at least by parameters μ_{l,w}, and σ_{l,w}, where μ_{l,w} is a mean parameter associated with the first lognormal statistical distribution characterizing the weights of the layer, and σ_{l,w} is a standard deviation parameter associated with the first lognormal statistical distribution.

Adjusting the weights of the weighted connections for the layer may include iteratively adjusting, according to an optimization process performed during an initial optimization period, one or more of the parameters μ_{l,w}, and σ_{l,w} to cause adjustment of the weighted connections to optimize performance of the network, and iteratively adjusting, during a second optimization period subsequent to the initial optimization period, one or more of the weights of the weighted connections of the layer to optimize the performance of the network.

Iteratively adjusting, during the initial optimization period, the one or more of the parameters μ_{l,w}, and σ_{l,w} can further include adjusting the one or more weights of the weighted connections during the initial optimization period to fit an adjusted first statistical distribution model derived from the adjusted one or more of the parameters μ_{l,w}, and σ_{l,w}.

Iteratively adjusting the weights of the weighted connections during the second optimization period can include iteratively adjusting the one or more weights of the weighted connections during the second optimization period, using the optimization process to minimize an error function defined for the optimization process, subject to at least one constraint that the weights of the weighted connections of the layer approximate a particular first statistical distribution process derived from fixed values of the one or more of the parameters μ_{l,w}, and σ_{l,w}.

Adjusting the weights of the weighted connections for the layer may include initializing the weights of the weighted connections for the layer according to initial parameter values defining the first statistical distribution model for the layer.

The ML system can be a neural network system, the ML elements can include neural network neurons, and the second statistical distribution model is a second lognormal distribution defined at least by parameters μ_{l,N}, and σ_{l,N}, where μ_{l,N} is a mean parameter associated with the second lognormal statistical distribution representing characteristics of outputs produced by the neurons in the layer, and σ_{l,N} is a standard deviation parameter associated with the second lognormal statistical distribution.

The parameters defining the operations of the neurons can include neuron parameters to control the output produced by the neurons, with the neuron parameters controlling one or more operations including, for example, summing the weighted inputs respectively received at each of the neurons, biasing the resultant sum to produce a resultant biased value by the each of the neurons, and/or applying an activation function to the resultant biased value produced by the each of the neurons.

The activation function used by the each of the neurons can include a rectified linear unit (ReLU)-based function.

Adjusting at least one of the ML element parameters and the adjustable second parameters for the second statistical distribution model may include at least one of, for example, iteratively adjusting, according to an optimization process, one or more of the parameters μ_{l,N}, and σ_{l,N} associated with the second lognormal distribution model to cause adjustment of the neuron parameters to optimize performance of the network, and/or iteratively adjusting respective neuron parameters for one or more of the neurons in the layer to optimize the performance of the network.

Iteratively adjusting the respective neuron parameters can include iteratively adjusting the respective neuron parameters for one or more of the neurons using the optimization process to minimize an error function defined for the optimization process, subject to at least one constraint that outputs of the neurons in the layer approximate a particular second lognormal distribution model corresponding to fixed values of at least the parameters μ_{l,N}, and σ_{l,N}.

The method may further include assigning the one or more of, for example, the weights, the ML parameters, the adjustable first parameters, and/or the adjustable second parameters, to bins. Adjusting the one or more of the weights, the ML parameters, the adjustable first parameters, and/or the adjustable second parameters can include adjusting the one or more of, for example, the weights, the ML parameters, the adjustable first parameters, and/or the adjustable second parameters according to the assigned bins.

In some variations, a machine learning (ML) system is provided that includes one or more memory storage devices, and one or more processor-based controllers in electrical communication with the one or more memory storage devices. The one or more processor-based controllers are configured to determine for a layer, l, of the ML system with multiple layers, L, sets of parameters defining one or more statistical distribution models used for directing the ML system to an optimized configuration, with each of the multiple layers being connected to one or more other layers through weighted connections, and with each layer including respective configurable ML elements to perform adjustable operations on weighted data received through the weighted connections. The one or more processor-based controllers are further configured to adjust one or more of:
at least one of, a) weights of the weighted connections of the layer according to a first set of parameters defining a first statistical distribution model to control characteristics of the weights, and/or b) adjustable first parameters of the first set of parameter defining the first statistical distribution model, and/or
at least one of, c) ML element parameters defining operations of at least some of the configurable ML elements of the layer according to a second set of parameters, defining a second statistical distribution model, to control operational characteristics of the ML elements, and/or d) adjustable second parameters, of the second set of parameters defining the second statistical distribution model.

In some variations, non-transitory computer readable media is provided that includes computer instructions executable on a processor-based device to determine for a layer, l, of a machine learning (ML) system with multiple layers, L, sets of parameters defining one or more statistical distribution models used for directing the ML system to an optimized configuration, with each of the multiple layers being connected to one or more other layers through weighted connections, and with each layer including respective configurable ML elements to perform adjustable operations on weighted data received through the weighted connections. The computer instructions are further configured to cause the processor-based device to adjust one or more of:
at least one of, a) weights of the weighted connections of the layer according to a first set of parameters defining a first statistical distribution model to control characteristics of the weights, and/or b) adjustable first parameters of the first set of parameter defining the first statistical distribution model, and/or
at least one of, c) ML element parameters defining operations of at least some of the configurable ML elements of the layer according to a second set of parameters, defining a second statistical distribution model, to control operational characteristics of the ML elements, and/or d) adjustable second parameters of the second set of parameters defining the second statistical distribution model.

Embodiments of the system and the computer readable media may include one or more of the features described in the present disclosure, including one or more of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1 is a schematic diagram of an example neural network system that is configurable according to the approaches described herein.

FIG. 2 includes plots showing size-weighted distributions for several layers in each of a BlazePose network and a BERT-Small network.

FIG. 3 includes plots showing size weighted distributions for a couple of layers in each of a VGG16 network and an LLAMA-13B network.

FIG. 4 includes plots showing the distribution of weight values in layers with low number of connections, for different networks.

FIG. 5 includes plots of average neuronal outputs resulting from processing images by a VGG16 network.

FIG. 6 is a flowchart of an example procedure for configuring a machine learning system.

Like reference symbols in the various drawings indicate like elements.

### DESCRIPTION

Described herein is a proposed framework for constructing/configuring machine learning systems, such as deep neural networks (with such networks implemented according to various different architectures), by adjusting the weights of weighted connections of a particular layer according to a statistical distribution model such as a lognormal distribution, by adjusting/configuring the operability (functionality) of the neurons of the particular layer, and/or by adjusting the parameters defining the statistical distribution model being used. The present disclosure presents a game-theoretic framework that addresses key issues about the micro-structure of deep-neural network models. Unlike the physics-based perspective, the framework accounts for the benefit-cost trade-offs that neurons and connections perform in their information-processing activities. It can be shown that a fully trained network is in a state of arbitrage equilibrium, which is characterized by two lognormal distributions of connection weights and neuronal output. This prediction of a universal microstructure is shown to be supported by data from seven large deep neural networks. This understanding should facilitate better training algorithms and custom hardware for many applications.

It can be shown both theoretically and empirically that in large neural networks the final connection strengths (i.e., weights) are distributed lognormally in highly connected layers. This universality is independent of the size of the network, its architecture, or its application domain. The intuitive explanation is that in a given layer, all individual connections contribute an effective utility (i.e., a net benefit) toward the overall objective of the network, which is to learn robustly the structure of a complex high-dimensional manifold by minimizing a loss function. In a large deep neural network, with hundreds of layers and millions of connections in each layer, no connection is particularly unique. No connection is more important than another. Every connection has thousands of counterparts elsewhere, and so no one is special. Therefore, there is an inherent symmetry in their microstructure. Hence, they all end up contributing the same effective utility towards that layer's goal of minimizing the loss function as the training progresses. That is why, when the training is completed, one reaches the arbitrage equilibrium where all effective utilities are equal in that layer.

The lognormal distribution feature for the weights of a deep neural network's layer and for the functionality (operability and output) of the network's neurons can be used to reduce the amount of time, data, and computational resources it takes to train large deep neural networks effectively. Several examples of ways by which this feature is used (with respect to weight adjustments) to more efficiently construct/configure a machine learning system follow.

First, since it is known that the final weight distribution is lognormal, the network configuration process can be ‘hot started’ to initialize the weights lognormally instead of initializing them randomly. In addition, since the average values of parameters such as μ′, σ′, A′, etc. (defining a lognormal distribution) have been determined, these parameter values can provide guidance about suitable initial weight values. Second, during training that is implemented using, for example, an iterative gradient descent procedure, instead of individually tuning millions of weights, the much smaller number of lognormal parameters can be tuned. In a particular layer that has tens of millions of weights whose values are supposed to adhere (conform) to a lognormal distribution modeled by just two or more parameters (e.g., μ and σ, and optionally A) a backpropagation process can be modified to tune just those three parameters rather than adjusting the tens of millions of weights in that particular layer. One could do this at least for the initial stages of training, and reserve the more resource-consuming fine-tuning of all the weights towards the last stages of training. This kind of hybrid training could result in considerable savings in data, time, and computational resources for large networks. Furthermore, since very large networks struggle to reach optimal allocation of weights, constraining the weight distribution to lognormal in the training iterations, which is the theoretical optimum, minimizes the chances of settling down with suboptimal microstructures. Third, special-purpose hardware can be developed, where the layers are connected in a lognormal manner with tunable/adjustable connection strengths.

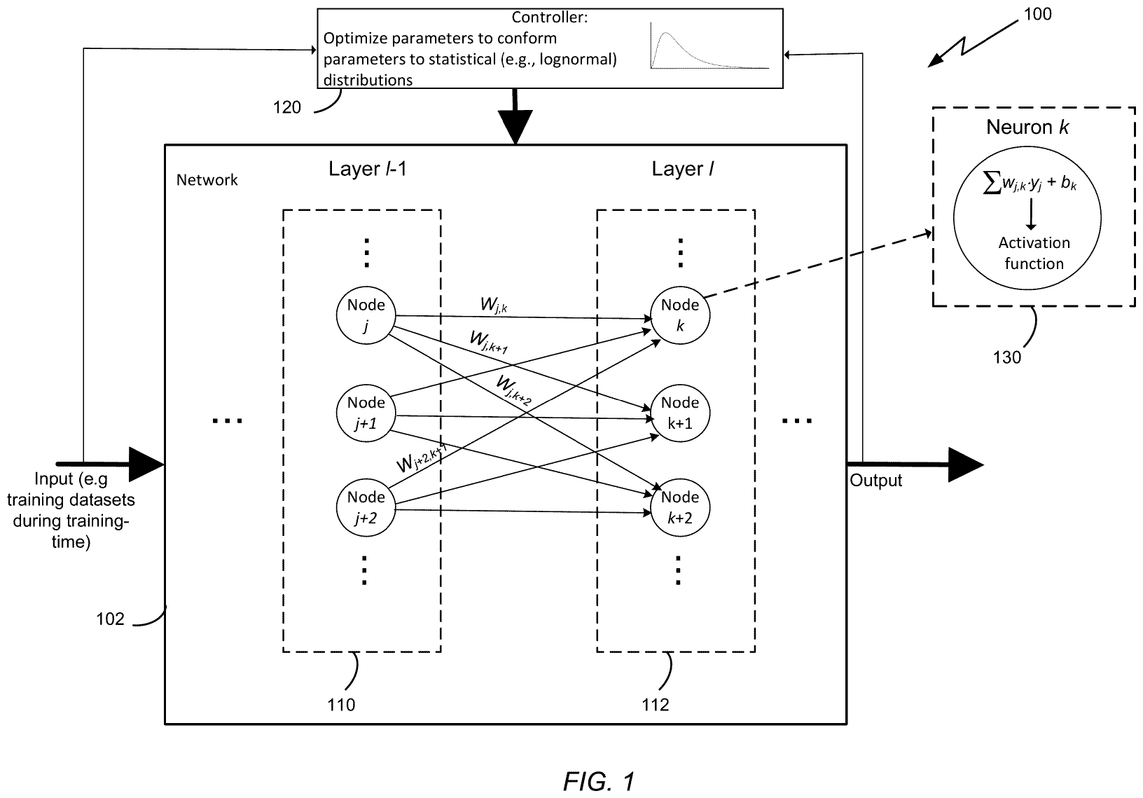

To illustrate, consider the simple example network 102 depicted in the schematic diagram 100 of FIG. 1. The schematic diagram shows a portion of the network that includes layer (l−1) 110 and layer l 112. In each of the layers only three nodes (e.g., neurons, in the case of a neural network architecture) are depicted, with the nodes of the (l−1) layer being fully connected to the nodes of layer l (a partially connected layer can also be used). The interconnecting weights (of which only a few are marked) are applied to outputs produced by the nodes of the layer (l−1). Node k of the layer l 112 is illustrated with more details in inset 130, depicting the node as a neuron k. The neuron k includes adjustable parameters that can be adjusted to control its behavior. For example, neurons in the network 102 may have adjustable parameters to control the summing operations, biasing operations, and/or applying activation functions operations so as to control the output produced by the respective neurons. The behavior of particular neurons can be controlled (e.g., by a controller 120 depicted in FIG. 1) so that output values in the particular layer that includes the neuron k conform (adhere) to a lognormal distribution (or some other distributions). Note that the particular properties of the distribution can be adjusted during an optimization process to minimize some error function between, for example, the output produced by the network (i.e., at the output layer) and ground truth data corresponding to input samples that produced the network's output.

The controller 120 controls, among other things, the optimization process applied during training, to minimize a loss metric between predictions made by the machine learning network and the ground truth output of training samples that cause the network in its current (pre-optimized) configuration to produce the predicted output. The optimization process can be performed using, for example, a gradient descent procedure. Based on the error metric produced in response to processing of input training data, the controller can adjust one or more sets of adjustable parameters that will then be used by the network during the subsequent iteration. The controller, in some embodiments, is configured to adjust the weights of weighted connections between layers, adjustable parameters that control the behavior of one or more of the neurons (e.g., the output produced by such one or more of the neurons), and adjustable parameters that control the desired statistical distribution (e.g., a lognormal distribution) that can, in turn, be used to adjust the behavior of the network (e.g., the whole network, specific layers, weights, and/or neurons) to thus steer the configuration of the network to an optimal state. As will become apparent below, optimized characteristics and behavior of certain elements (e.g., weights, neuronal parameters) tend to conform with a lognormal statistical distribution. For example, in a fully optimized neural network, the distribution of weight values of weight connections in a particular layer (or a collection of layers) will approximate a lognormal distribution.

Thus, as a way to speed up (and/or conserve resources) an optimization process, adjustment of adjustable parameters of the network, such as weights of a particular layer, does not need to necessarily be made based on the error metric, but instead can be made so that the weights in that layer can approximate a lognormal distribution that was derived based on the error metric. That is, the controller can, based on the error metric, adjust parameters of a lognormal distribution (or some other distribution, when a different type of ML architecture, or some other optimization objective is used) that in turn will cause adjustable parameters in one or more layers to be adjusted according to the revised lognormal distribution(s) rather than being directly adjusted based on the error metric computed by the controller. As noted, in some embodiments, different lognormal distributions can be derived for different layers to then adjust the adjustable parameters (e.g., weights and parameters controlling operations of neurons) of a particular layer according to the corresponding lognormal distribution for that layer. Alternatively, a lognormal distribution can be computed (during an iteration of the training stage and/or intermittently during runtime when the network needs to be updated) to control adjustments of network parameters for multiple layers, or even for the entire network (note that separate lognormal distribution are needed for the weight parameters and neuron parameters, respectively).

As noted, in some embodiments, the lognormal distribution(s) can be used to directly guide the adjustment of network parameters (i.e., the adjustment of parameters is based on computed lognormal distributions) and/or to act as a constraint to the adjustment of network parameters when they are adjusted based on the error metric produced for the error function. For example, in some embodiments, the optimization process may be such that during an initial stage, lognormal characteristics (for one or more distributions) are adjusted at some or all iterations based on error metrics computed during that iteration. Subsequently, network parameters are adjusted based on the adjusted lognormal distribution(s). At a second stage, after the ML system parameters have been sufficiently adjusted so they begin to approximate the current respective lognormal distributions, the network parameters (e.g., for weights or neurons) can be adjusted based on the error metrics (the lognormal distributions can continue to be adjusted during the second stage).

Further details regarding the use of particular statistical distributions to configure and optimize a machine learning system are provided below, with a focus on the use of lognormal distributions to guide a network's (e.g., neural network's) optimization process.

In a typical deep neural network training regimen using gradient descent, the backpropagation algorithm and regularization procedures gently guide all connections to modify their weights and biases so that the overall error function is minimized over many iterations and over many datasets. Consider the final values of the weights and biases of a fully trained network as the optimal values of the neurons and their connections. The iterative process of getting there may be modeled as a competition between the neurons and the connections to get there as quickly as possible. This naturally lends itself to a game-theoretic approach, which is formulated using a framework called statistical teleodynamics. It is a synthesis of the central concepts and techniques of population game theory with those of statistical mechanics.

In population games, one is interested in predicting the final outcome(s) of a large population of goal-driven agents competing dynamically to increase their respective utilities. In particular, one would like to know whether such a game would lead to an equilibrium outcome. For some population games, one can identify a single scalar-valued global function, called a potential ϕ(x) (where x is the state vector of the system) that captures the necessary information about the utilities of the agents. The gradient of the potential is the utility. A potential game reaches strategic equilibrium, called Nash equilibrium, when the potential ϕ(x) is maximized. Furthermore, this equilibrium is unique if ϕ(x) is strictly concave (i.e., ∂²ϕ/∂²x<0). Therefore, an agent's utility, hₖ, in state k is the gradient of potential ϕ(x), i.e., hₖ(x)≡∂ϕ(x)/∂xₖ where xₖ=Nₖ/N, x is the population vector, Nₖ is the number of agents in state k, and N is the total number of agents. By integration, this yields,

$$ϕ ( x ) = {\sum }_{k = 1}^{m} \int {h}_{k} ( x ) d {x}_{k} , \qquad ( 1 )$$

where m is the total number of states.

To determine the maximum potential, one can use the method of Lagrange multipliers with [symbol] as a Lagrangian and λ as a Lagrange multiplier for the constraint Σₖ₌₁^{m}xₖ=1, providing:

$$ℒ = ϕ + λ ( 1 - {\sum }_{k = 1}^{m} {x}_{k} ) . \qquad ( 2 )$$

In equilibrium, all agents enjoy the same utility, that is, hₖ=h*. It is an arbitrage equilibrium where agents no longer have any incentive to switch states, as all states provide the same utility h*. Thus, the maximization of ϕ and hₖ=h* are equivalent when the equilibrium is unique (i.e., ϕ(x) is strictly concave). This formalism is used to model the competitive dynamics between neurons and between connections in a deep neural network.

There are two local competitions that are happening simultaneously in every layer, one between the connections and the other between the neurons. Consider first the competition between the connections in a deep neural network with L layers of neurons. Let layer l have N^{l} neurons that are connected to neurons in layer l−1 using M^{l} connections. To benefit from the statistical properties of large numbers, assume that N^{l} and M^{l} are large, e.g., on the order of millions. These connections have weights, which can be positive or negative, that determine the strength of the connections. In the proposed framework, all weights are scaled to the range of 0 to 1, which is divided into m bins, with any given connection belonging to one of the m bins. The strength of connection of a neuron i in layer l that is connected to a neuron j in layer l−1, and belonging to bin k, is denoted by wᵢⱼₖ^{l}. The number of connections in bin k is given by Mₖ^{l} with the constraint M^{l}=Σₖ₌₁^{m}Mₖ^{l}. The total budget for weights is constrained by W^{l}=Σₖ₌₁^{m}Mₖ^{l}|wᵢⱼₖ^{l}|.

The deep neural network is human-engineered or has naturally evolved to meet certain goals and deliver certain performance targets efficiently and robustly. Here efficiency is a measure of how effectively the network minimizes the error or loss function with minimal use of resources. For example, maintaining neurons and connections incurs costs such as computing power, memory, time, energy, etc. One would like the network to meet its performance target of making accurate predictions with minimal use of such resources. Robustness refers to the ability to deliver the performance target despite variations in its operating environment, e.g., making accurate predictions in test datasets that are different from its training datasets.

The effective utility (hᵢⱼₖ^{l}) of a connection with a weight of (wᵢⱼₖ^{l}) in layer l is defined as a measure of the contribution that this connection makes to reducing the error function robustly. In this perspective, the goal of every neuron is to stay connected with other neurons so that it can receive, process, and send information efficiently under different conditions to minimize the error function. The more connections of varying weights it has, the more robust is its membership in the network against the loss of connections and/or neurons. The effective utility of a connection is a benefit-cost trade-off function. It is the net benefit contributed by a connection after accounting for the costs of maintenance and competition, as will be discussed in greater detail below.

Thus, the effective utility hᵢⱼₖ^{l} is made up of three components,

$${h}_{ijk}^{l} = {u}_{ijk}^{l} - {v}_{ijk}^{l} - {s}_{ijk}^{l} , \qquad ( 3 )$$

where uᵢⱼₖ^{l} is the informational benefit derived from the strength of the connection, vᵢⱼₖ^{l} is the cost or disutility of maintaining such a connection, and sᵢⱼₖ^{l} is the disutility of competition between the connections. Dis-utilities are costs to be subtracted from the benefit uᵢⱼₖ^{l} to determine the net benefit.

In general, as the strength of the connection wᵢⱼₖ^{l} increases, the marginal utility of its contribution decreases. This diminishing marginal utility is a common occurrence for many resources and is usually modeled as a logarithmic function. Therefore, the utility uᵢⱼₖ^{l} can be written as uᵢⱼₖ^{l}=αln|wᵢⱼₖ^{l}|, where |wᵢⱼₖ^{l}| signifies that uᵢⱼₖ^{l} depends on the absolute magnitude and not on the sign of the weight, and α>0 is a parameter. But, as noted, this benefit comes with a cost, as building and maintaining connections are not free. In biology, there are metabolic and energetic costs in creating and maintaining molecules and reactions associated with connections. In artificial neural networks, there are computational and performance costs. For example, it is well known that as weights increase, key performance metrics such as generalization accuracy and training time suffer, necessitating various regularization techniques. Such costs are taken into account in vᵢⱼₖ^{l}. The appropriate model for this cost is a quadratic function, which has been successfully demonstrated for other dynamical systems, such as the emergence of income distribution, flocking of birds, and social segregation. Therefore, using the expression vᵢⱼₖ^{l}β(ln|wᵢⱼₖ^{l}|)², yields:

$${u}_{ijk}^{l} - {v}_{ijk}^{l} = α ln \vert {w}_{ijk}^{l} \vert - {β ( ln \vert {w}_{ijk}^{l} \vert )}^{2} , \qquad ( 4 )$$

where β>0 is another parameter.

As more and more connections accumulate in the same bin q (that is, having the same weight or being in the sane weight sub-range), each new connection is less valuable to the neuron. In other words, a connection is less valuable if it is one of the many rather than one of the few in its class. Therefore, a neuron would prefer the connections to be distributed over all the bins and not have them concentrated in just a few bins. This is enforced by another cost term sᵢⱼₖ^{l}, the competition cost. Appealing to diminishing marginal (dis)utility again, the competition cost can be modelled as γ ln Mₖ^{l}, where γ>0 is another parameter. This choice has also been successfully demonstrated for other systems. Therefore, the effective utility hᵢⱼₖ^{l} is given by:

$${h}_{ijk}^{l} = α ln \vert {w}_{ijk}^{l} \vert - {β ( ln \vert {w}_{ijk}^{l} \vert )}^{2} - γ ln {M}_{k}^{l} . \qquad ( 5 )$$

Setting γ=1, the above expression can be re-written as:

$${h}_{ijk}^{l} = α ln \vert {w}_{ijk}^{l} \vert - {β ( ln \vert {w}_{ijk}^{l} \vert )}^{2} - ln {M}_{k}^{l} . \qquad ( 6 )$$

All these connections compete with each other to increase their respective effective utilities in their role to robustly reduce the overall error function. They do this by switching from one state to another by dynamically changing the weights wᵢⱼₖ^{l}, depending on the local gradient of hᵢⱼₖ^{l}, as in gradient descent.

One of the important results in potential game theory is that this competitive dynamics will result in a Nash equilibrium where the potential ϕ_{w}^{l}(x) is maximized. All agents enjoy the same utility in equilibrium—i.e., hᵢⱼₖ^{l}=h^{l*} for all i, j and k, where the superscript (*) denotes the equilibrium state. This is an arbitrage equilibrium as all agents have the same utility, thus removing any incentive to switch states.

Using Equation (6), the layer connection potential ϕ_{w}^{l} can be expressed as:

$${ϕ}_{w}^{l} ( x ) = {ϕ}_{u}^{l} - {ϕ}_{v}^{l} - {ϕ}_{s}^{l} , \qquad ( 7 )$$

$$where$$

$${ϕ}_{u}^{l} = α {\sum }_{k = 1}^{m} {x}_{k}^{l} ln \vert {w}_{ijk}^{l} \vert , \qquad ( 8 )$$

$${ϕ}_{v}^{l} = - β {\sum }_{k = 1}^{m} {{x}_{k}^{l} ( ln \vert {w}_{ijk}^{l} \vert )}^{2} , and \qquad ( 9 )$$

$${ϕ}_{s}^{l} = \frac{1}{{M}^{l}} ln \frac{{M}^{l} !}{{\prod }_{k = 1}^{m} ( {M}^{l} {x}_{k} ) !} , \qquad ( 10 )$$

where xₖ=Mₖ^{l}/M^{l}, and with Equation (10) derived based on Stirling's approximation. The function ϕ_{w}^{l}(x) is strictly concave, and thus

$$\frac{{\partial }^{2} {ϕ}_{w}^{l} ( x )}{\partial {x}_{k}^{2}} = - \frac{1}{{x}_{j}} < 0.$$

Therefore, a unique Nash Equilibrium for this game exists, where ϕ_{w}^{l}(x) is maximized. Using the Lagrangian multiplier approach, ϕ_{w}^{l}(x) is maximized to determine that the equilibrium distribution of the connection weights follows a lognormal distribution, given by:

$${x}_{k}^{*} = \frac{1}{\sqrt{2 π} {σ}_{w} \vert {w}_{ijk}^{l} \vert} exp [ - \frac{{( ln \vert {w}_{ijk}^{l} \vert - {μ}_{w} )}^{2}}{2 {σ}_{w}^{2}} ] , \\ where , {μ}_{w} = \frac{α + 1}{2 β} and {σ}_{w} = \sqrt{\frac{1}{2 β}} \qquad ( 11 )$$

Thus, a fully trained deep neural network, its microstructure, i.e., the distribution of connection weights, is lognormal for all layers. This universality is independent of its macroscopic architecture or its application domain.

The intuitive explanation is that, in a given layer, all individual connections contribute an effective utility (i.e., a net benefit) toward the overall objective of the network, which is to robustly minimize the error function. In a large deep neural network, with hundreds of layers and millions of connections in each layer, no connection is particularly unique. No connection is more important than another. Every connection has thousands of counterparts elsewhere, so no one is special. Therefore, there is this inherent symmetry and equality in the microstructure. So, when training is completed, the network reaches the arbitrage equilibrium where all effective utilities are equal in that layer, i.e., hᵢⱼₖ^{l}=h^{l*} for all i, j, and k. Furthermore, in the “thermodynamic limit” of extremely large networks, i.e., L→∞, M→∞, and W→∞, all connections in all the layers end up making the same effective utility contribution, i.e., hᵢⱼₖ^{l}=h^{l*} for all i, j, and k. Therefore, all layers will have a lognormal weight distribution for this ideal deep neural network with the same μ and σ. In other words, α and β are the same for all layers. This is the ultimate universal microstructure for ideal deep neural networks.

The potential component ϕₛ^{l} can be interpreted as entropy. Thus, by maximizing ϕ_{w}^{l} in the Lagrangian multiplier formulation, the entropy is equivalently maximized subject to the constraints specified in the terms ϕᵤ^{l} and ϕᵥ^{l}. Accordingly, the lognormal distribution is the maximum entropy distribution under these constraints.

For the entire network of L layers, the network connection-potential Φ_{w} as,

$${Φ}_{w} = {\sum }_{l = 1}^{L} {ϕ}_{w}^{l} = {\sum }_{l = 1}^{L} ( {ϕ}_{u}^{l} + {ϕ}_{v}^{l} + {ϕ}_{s}^{l} ) , \qquad ( 12 )$$

$${Φ}_{w} = {\sum }_{l = 1}^{L} {\sum }_{k = 1}^{M} [ α {x}_{k}^{l} ln \vert {w}_{ijk}^{l} \vert - β {{x}_{k}^{l} ( ln \vert {w}_{ijk}^{l} \vert )}^{2} ] + {S}_{w} , \qquad ( 13 )$$

where S_{w}=Σₗ₌₁^{L}ϕₛ^{l} is the network-wide connection entropy of all connections in all layers.

Having analyzed the behavior of the network from the perspective of connections, the perspective of the effect of the neurons' operations on the network's behavior is next considered. Analysis of the microstructure of the deep learning models is based on competition between neurons. Much of the analysis discussed with respect to the weighted connections also applies to the neurons' operations perspective, with some changes reflecting the accommodations required for neurons. Here, the competition is between all neurons, N^{l}, in the layer l. It is assumed that this competition is local, i.e., the neurons in a layer l compete only with each other, and not with the neurons in the other layers. Each neuron performs two main tasks of information processing. The first is to compute the weighted sum of all the signals it receives from the neurons to which it is connected in the layer l−1. For a neuron i in layer l that is connected to N(l−1) neurons in layer l−1, this is given by:

$${z}_{i}^{l} = {\sum }_{j = 1}^{{N}^{l - 1}} {w}_{ij}^{l} {y}_{j}^{l - 1} + {b}_{i}^{l} \qquad ( 14 )$$

where yⱼ^{l-1} is the output of the neuron j in layer l−1, wᵢⱼ^{l} is the connection weight between the neurons i and j, and bᵢ^{l} is the bias of the neuron i in layer l. The second task is to generate an appropriate output response, yᵢ^{l}, from the input zᵢ^{l} using its activation function and send it to all neurons to which it is connected in the layer l+1. Combining these two information-processing tasks yields the following formulation:

$${Z}_{i}^{l} = {z}_{i}^{l} {y}_{i}^{l} = ( {\sum }_{j =}^{{N}^{l - 1}} {w}_{ij}^{l} {y}_{j}^{l - 1} + {b}_{i}^{l} ) . \qquad ( 15 )$$

The quantity Zᵢ^{l} is believed to be an important fundamental quantity of information processing that should be recognized with its own name and identity. This product of the input datum and the output datum is referred to as an iotum (plural, iota). It can be thought of as a quantum of information processing activity by the neuron i towards the minimization of the error function. Like the connection weight, the iotum is the neuron's “weight.” The iota Zᵢ^{l} is computed for all N^{l} neurons in layer l. This is followed by determining the minimum and maximum values, and dividing the range into n bins (n<<N^{l}). Therefore, each iotum will be in one of these bins (say, q^{th} bin of value Z_{q}^{l}), and let the number of neurons in the q^{th} bin be N_{q}^{l}.

As noted above, an effective utility, hᵢⱼₖ^{l}, for a connection in deep neural network is defined as the measure of contribution that that connection makes to reducing the error function robustly. Similarly, the effective utility H_{q}^{l} of a neuron in the q^{th} bin for a layer l is given by:

$${H}_{q}^{l} = {U}_{q}^{l} - {V}_{q}^{l} - {S}_{q}^{l} , \qquad ( 16 )$$

where U_{q}^{l} is the computational benefit provided by the neuron in state q by processing Z_{q}^{l}, and V_{q}^{l} and S_{q}^{l} are the computational and competition costs, respectively, incurred by the neuron in this activity. As was the case for the weights' effective utility, the components of the effective utility H_{q}^{l} of a neuron can be defined as follows:

$${U}_{q}^{l} = η ln {Z}_{q}^{l} , \qquad ( 17 )$$

$${V}_{q}^{l} = {ζ ( ln {Z}_{q}^{l} )}^{2} , \qquad ( 18 )$$

$${S}_{q}^{l} = ln {N}_{q}^{l} , \qquad ( 19 )$$

for η>0 and ζ>0. H_{q}^{l} can therefore be expressed as:

$${H}^{l *} = η ln {Z}_{q}^{l} - {ζ ( ln {Z}_{q}^{l} )}^{2} - ln {N}_{q}^{l} , \qquad ( 20 )$$

This again leads to a lognormal distribution, namely:

$${x}_{q}^{l *} = \frac{1}{\sqrt{2 π} {σ}_{N} {Z}_{q}^{l}} exp [ - \frac{{( ln {Z}_{q}^{l} - {μ}_{N} )}^{2}}{2 {σ}_{N}^{2}} ] , \\ where , {x}_{q}^{l *} = {N}_{q}^{l *} / {N}^{l} , {μ}_{N} = \frac{η + 1}{2 ζ} and {σ}_{N} = \sqrt{\frac{1}{2 ζ}} . \qquad ( 21 )$$

The layer's neuron potential Φ_{N} can be determined as:

$$\begin{matrix}{ϕ}_{N}^{l} = {\sum }_{q} \int {H}_{q}^{l} {dN}_{q}^{l} \\ = η {\sum }_{q = 1}^{n} {x}_{q}^{l} ln {Z}_{q}^{l} - ζ {\sum }_{q = 1}^{n} {{x}_{q}^{l} ( ln {Z}_{q}^{l} )}^{2} - \frac{1}{{N}^{l}} ln \frac{{N}^{l} !}{{\prod }_{q = 1}^{n} ( {N}_{q}^{l} ) !} \\ = η {\sum }_{q = 1}^{n} {x}_{q}^{l} ln {Z}_{q}^{l} - ζ {\sum }_{q = 1}^{n} {{x}_{q}^{l} ( ln {Z}_{q}^{l} )}^{2} + {S}_{N}^{l}\end{matrix} , \\ where {S}_{N}^{l} = \frac{1}{{N}^{l}} ln \frac{{N}^{l} !}{{\prod }_{q = 1}^{n} ( {N}_{q}^{l} ) !} \qquad ( 22 )$$

is the layer neuron entropy.

For the entire network of L layers, the network-wide neuron-potential Φ_{N} is:

$${Φ}_{N} = {\sum }_{l = 1}^{L} {ϕ}_{N}^{l} = {\sum }_{l = 1}^{L} {\sum }_{q = 1}^{n} [ η {x}_{k}^{l} ln {Z}_{q}^{l} - ζ {{x}_{q}^{l} ( ln {Z}_{q}^{l} )}^{2} ] + {S}_{N} , \qquad ( 23 )$$

where S_{N}=Σₗ₌₁^{L}S_{N}^{l} is the network-wide neuron entropy. The neurons in a given layer l reach the arbitrage equilibrium when ϕ_{N}^{l} is maximized, and all neurons in all layers reach the arbitrage equilibrium when Φ_{N} is maximized at the end of the training process for the entire network.

Note that here too the error or loss function does not appear in the equations for potential functions. Only the equilibrium state is considered, which is achieved at the end of the network's training when the error is zero for the ideal network.

Using the expression for a neuron's data processing functionality, as provided in Equation (14), the ReLU activation function can be expressed as:

$${y}_{i}^{l} = ReLU ( {z}_{i}^{l} ) = ReLU ( {\sum }_{j = 1}^{{N}^{( l - 1 )}} {w}_{ij}^{l} {y}_{j}^{( l - 1 )} + {b}_{i}^{l} ) , \qquad ( 24 )$$

where yᵢ^{l} is the ReLU activation output of the i^{th} neuron in the l^{th} layer.

Given that yᵢ^{l}=ReLU (zᵢ^{l})=0 for zᵢ^{l}<0, and yᵢ^{l=z}ᵢ^{l} for zᵢ^{l}>0, it follows that

$${Z}_{q}^{l} = {z}_{q}^{l} {y}_{q}^{l} = {( {Z}_{q}^{l} )}^{2} = {( {y}_{q}^{l} )}^{2} , and \\ {Z}_{i}^{l} = {z}_{i}^{l} {y}_{i}^{l} = {( {z}_{i}^{l} )}^{2} = {( {y}_{i}^{l} )}^{2} . \qquad ( 25 )$$

It follows, therefore, that:

$${H}^{l *} = \hat{η} ln {y}_{q}^{l} - {\hat{ζ} ( ln {y}_{q}^{l} )}^{2} - ln {N}_{q}^{l *} , \qquad ( 26 )$$

where \hat{η}=2η and \hat{ζ}=4ζ.

This leads to the lognormal distribution in y_{q}^{l} of:

$${x}_{q}^{l *} = \frac{1}{\sqrt{2 π} {\hat{σ}}_{N} {y}_{q}^{l}} exp [ - \frac{{( ln {y}_{q}^{l} - {\hat{μ}}_{N} )}^{2}}{2 {\hat{σ}}_{N}^{2}} ] , \qquad ( 27 )$$

$$where {x}_{q}^{l *} = {N}_{q}^{l *} / {N}^{l} , {\hat{μ}}_{N} = \frac{\hat{η} + 1}{2 \hat{ζ}} , and {\hat{σ}}_{N} = \sqrt{\frac{1}{2 \hat{ζ}}} .$$

Therefore, for the special case of ReLU, the neuronal output y_{q}^{l} follows a lognormal distribution (as verified in the experiments performed to evaluate the approaches discussed herein).

In summary, during training, there are two local competitions that are happening simultaneously, one between the connections and the other between the neurons in every layer. At the end of the training, both the connections and the neurons' operation characteristics reach their respective arbitrage equilibrium when Φ_{w} and Φ_{N} are maximized, respectively. These arbitrage equilibria result in the emergence of two (generally different) lognormal distribution—one for connection weights and the other for neuronal iota.

Maximizing the potential (Φ_{w} or Φ_{N}) is equivalent to maximizing the entropy (S_{w} or S_{N}) with the appropriate constraints. A procedure for configuring a neural network to achieve maximum potential can therefore be referred to as a maximum entropy design procedure. The maximum entropy design procedure distributes the connection weights (given by the lognormal distribution in Equation (11)) and neuronal iota (given by the lognormal distribution in Equations (21) or (27)) in the network in such a way that it maximizes the information-theoretic uncertainty about a wide variety of future datasets whose nature is unknown, unknowable, and, therefore, uncertain. Thus, in maximum-entropy designs, the network is optimized for all potential future environments, not for any particular one. Note that for any particular dataset, one can design a weight distribution such that it will outperform the maximum entropy design with respect to the error function. However, such a biased network may not perform as well for other datasets, while the maximum entropy distribution-based network is likely to perform better. For instance, if a network is overfitted on a specific dataset, then it might “memorize” these data samples and hence might not generalize that well for other datasets.

To prevent this, techniques such as data segmentation, weight regularization, dropout, early stopping, etc., can be used. The effect of such procedures is to achieve robustness in performance on a wide range of datasets. The goal of such techniques is to accommodate as much variability and as much uncertainty as possible in test environments.

This is what is achieved by maximizing entropy according to the approaches described herein. Maximizing entropy is equivalent to maximizing the uncertainty and variability of future datasets. Under the proposed approaches, the robustness requirement is naturally built in from the very beginning as an integral part of the effective utility and potential function formulation. Therefore, the maximum entropy design procedure leads to optimally robust implementations.

Thus, an optimally robust deep neural network is a robust learning and prediction engine. It is a maximum entropy machine that learns an efficient and robust model of the target manifold (such a network implementation can be referred to as Jaynes Machine in honor of Professor E. T. Jaynes, who elucidated the modern interpretation of the maximum entropy principle in the 1950s).

Testing and evaluation of the proposed approaches were performed by analyzing the distributions of connections and neurons (and the parameters representing their trained behavior) in different networks. To evaluate the distribution of connection weights, the behavior and configuration of seven different deep neural networks were tested and analyzed. The deep neural networks included (i) BlazePose, (ii) Xception, (iii) VGGNet-16, (iv) BERT-Small, (v) BERT-Large, (vi) Llama-2 (7B), and (vii) LLAMA-2 (13B). The salient features of these networks are summarized in Table I, below.

TABLE I
Seven deep neural network case studies

| Model | Architecture | Parameter size | Application |
|---|---|---|---|
| BlazePose | Convolution | 2.8 × 10⁶ | Computer Vision |
| Xception | Convolution | 20 × 10⁶ | Computer Vision |
| VGGNet-16 | Convolution | 138 × 10⁶ | Computer Vision |
| BERT Small | Transformer | 109 × 10⁶ | NLP |
| BERT Large | Transformer | 325 × 10⁶ | NLP |
| LLAMA-2 (7B) | Transformer | 7 × 10⁹ | NLP |
| LLAMA-2 (13B) | Transformer | 13 × 10⁹ | NLP |

As can be seen from Table I, the first three networks utilize convolution layers, and the other four are based on the transformer architecture. They are of widely different sizes with respect to the number of parameters and are implemented for different application domains.

The layer-by-layer weight data for these networks was extracted, normalized between 0 and 1, converted to their absolute magnitudes by dropping the signs, and classified into different bins. For all these networks, some layers had only a few thousand data points (out of the millions or tens of millions in the network).

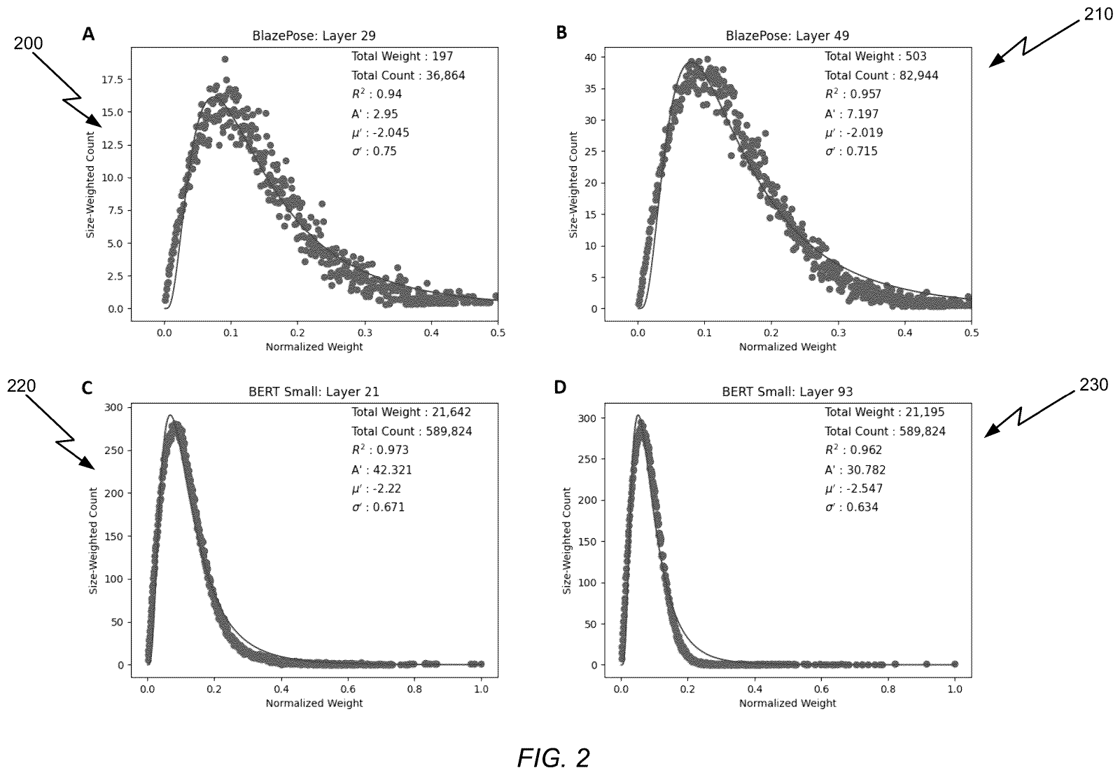

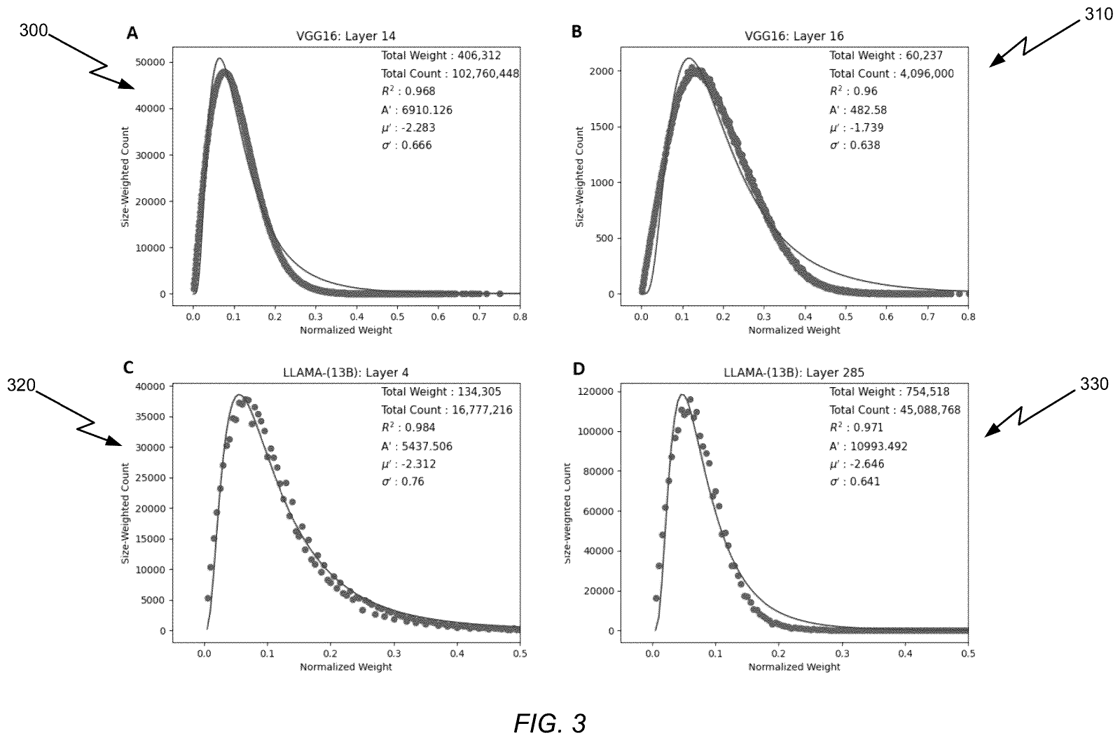

FIG. 2 includes plots showing size-weighted distributions for connection weights values for several layers in each of a BlazePose network and a BERT-Small network. Particularly, plots 200 and 210 are respective plots of the weight-size distribution of connection weights in layers 29 and 49 of a BlazePose network, while plots 220 and 230 are plots of the weight-size distributions of connections weights in layers 21 and 93 of a BERT-Small network. In the plots, the dots represent actual recorded data of the weight values, while the curves are lognormal curves fitted to the data. FIG. 3 includes plots showing the size weighted distributions for a couple of layers in each of a VGG16 network and an LLAMA-13B network. Specifically, Plots 300 and 310 are respective plots of the weight-size distribution of connection weights in layers 14 and 16 of the VGG16 network, while plots 320 and 330 illustrate the weight-size distribution of connections weights in layers 4 and 285 of a LLAMA-2 (13B) network.

The plots of FIGS. 2 and 3 show the size-weighted distributions (noted as size-weighted count on the y-axis) rather than the weight distribution, since the features are clearer in the former. The size-weighted count of a bin is simply the product of the weight of the bin and the number of connections in that bin. A well-known result in statistics provides that if a variate is distributed lognormally with μ and σ (i.e., LN(μ, σ)), then the size-weighted distribution of the variate is also lognormal, LN(μ′, σ′), where μ′=μ+σ² and σ′=σ. Furthermore, since the utility uᵢⱼₖ^{l} (as discussed above) is positive (since it is a benefit) and ln|wᵢⱼₖ^{l} is negative for the range of 0<|wᵢⱼₖ^{l}|<1, then α<0, μ<0, and μ′<0. Similarly, the disutility uᵢⱼₖ^{l} requires β>0. The parameter A′ is the scaling factor of the lognormal distributions.

FIGS. 2 and 3 illustrate that the size-weighted data fit the lognormal distribution very well with high R² values. This is typical for all layers with high connectivity. Although the seven networks use different architectures, are of different sizes, and are trained for different applications, the plots in FIGS. 2 and 3 show the universal microstructure of the connections' weights.

Table II, below, summarizes μ′ and σ′ for the seven case studies. Note that for large networks with greater than 100 million connections, σ′ appears to be nearly constant (around 0.65) for all networks, as seen by its low standard deviation values in Table II. This implies that β′ is also approximately constant for all networks. Even μ′ (and hence α′) appears to be in a narrow range (−2.3 to −3.0) for the different networks. It can therefore be inferred that μ′ and σ′ are constants (or near constant) for all networks in the “thermodynamic limit” of the ideal network. The approximately constant values μ′ and σ′ across the seven networks investigated suggests that the trend of nearly constant μ′ and σ′ values exists even for nonideal network cases.

TABLE II
Lognormal parameters for the size-weighted distribution of weights

| Model | Layers | R² | μ′ | σ′ |
|---|---|---|---|---|
| BlazePose | 39 | 0.93 ± 0.02 | −1.74 ± 0.52 | 1.49 ± 0.60 |
| Xception | 32 | 0.98 ± 0.01 | −2.87 ± 0.18 | 0.70 ± 0.05 |
| VGGNet-16 | 16 | 0.97 ± 0.01 | −2.36 ± 0.41 | 0.68 ± 0.05 |
| BERT Small | 75 | 0.96 ± 0.01 | −2.47 ± 0.95 | 0.65 ± 0.02 |
| BERT Large | 144 | 0.96 ± 0.01 | −2.37 ± 0.98 | 0.64 ± 0.01 |
| LLAMA-2 (7B) | 226 | 0.97 ± 0.01 | −2.96 ± 0.54 | 0.66 ± 0.05 |
| LLAMA-2 (13B) | 282 | 0.94 ± 0.03 39 | −3.02 ± 0.53 | 0.67 ± 0.06 |

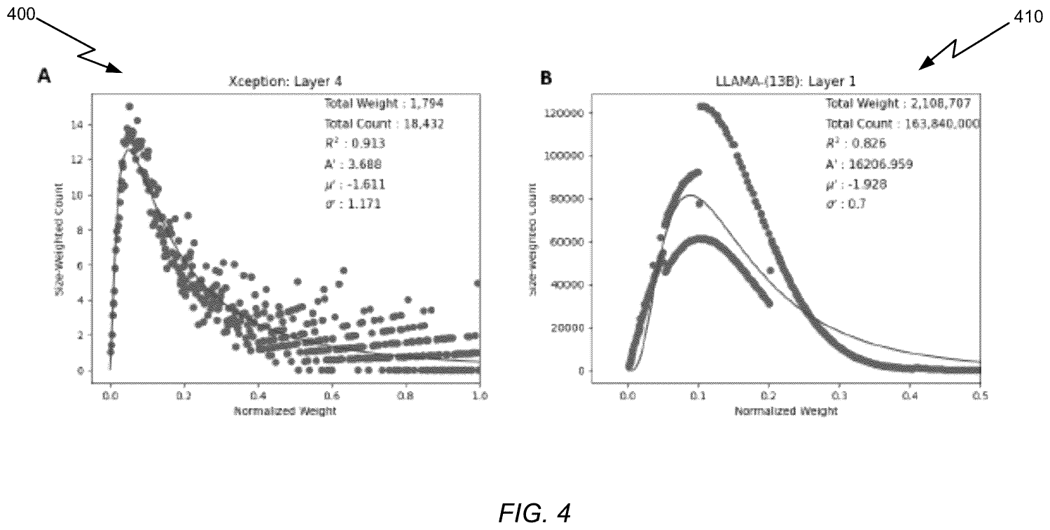

The number of connections in the 814 layers that were examined (from the seven networks) ranged from 36,864 to 163,840,000. The experiments showed that the more connections a layer has, the better is the lognormal fit with a higher R² due to better statistical averaging. FIG. 4 includes plots 400 and 410 showing the distribution of weight values in layers with low number of connections for different networks (Xception and LLAMA-13B, respectively). The plot 400 shows the distribution of weight values for the connections of layer #4 of the Xception network, which has only 18,432 connections. The distribution behavior of the data samples in the plot 400 shows that the data samples are relatively noisy, which makes it difficult to properly fit the data samples to known statistical distributions (although even in the noisy plot 400, the general outlines of the data sample follow a lognormal distribution).

On the other hand, layers with scores of millions of connections have their own challenges, as they are harder to train, and hence run the risk of suboptimal weight assignments. Recall that, as proposed in the approaches described herein, lognormal distribution can clearly emerge when the arbitrage equilibrium is reached. It is possible that for such extremely highly connected layers had not quite reached equilibrium when the training was stopped. Consider, for example, the plot 410 of FIG. 4 which shows size-weighted distribution data samples for layer #1 of the LLAMA-2 (13B) network, which has over 163 million weights. As can be seen in the plot 410, there are elements of the lognormal distribution present, but the fit is not as good as it is for the smaller LLAMA-2 in FIG. 3. This suggests that Layer #1 training was suboptimal. It appears from the empirical analysis that layers that have connections in the range of about 1 to 70 million have the right trade-off between better statistical properties and reaching optimal weight distribution.

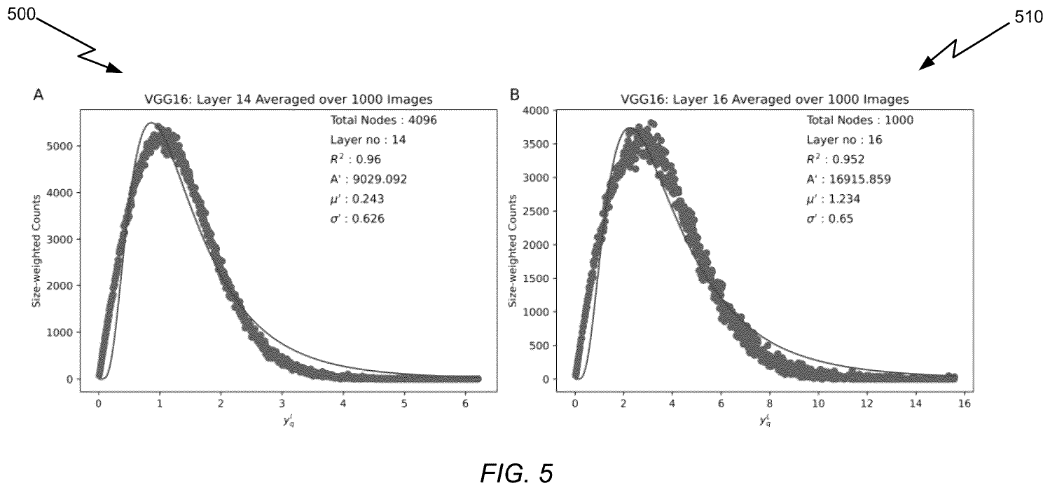

For the neuronal perspective, the resultant parameter values, represented by the neuronal data iota Z_{q}^{l} distribution for neurons in several layers of the various networks was examined. For ReLU-based networks, the neuronal output y, follows a lognormal distribution. An example of the experimental results is illustrated in FIG. 5, which includes plots 500 and 510 of resultant average neuronal outputs, y_{q}^{l}, averaged over a 1000 images processed by a VGG16 network, obtained at different layers of the network. Particularly, 1000 different images were presented to a VGGNet-16 network, and the corresponding values of yᵢ were recorded for all neurons in layers #14 and 16 for each image. The values were classified into 1000 bins and the average value of N_{q}^{l} over the 1000 images was calculated for all bins. The size-weighted counts were then plotted, as illustrated in FIG. 5. As expected, the neuronal outputs y_{q}^{l} closely fitted a lognormal distribution.

Thus, as discussed herein, the proposed approaches for configuring networks, such as neural networks, leverage the tendency of well-trained networks (i.e., networks at a final, or near-final state, of a training/optimization procedure) to have optimized characteristics that approximate certain statistical distributions. A machine-learning's effectiveness is determined by its ability to make accurate predictions robustly under different conditions. Under the proposed approaches, the learning process is formulated as an informational benefit-cost trade-off competition between neurons and between connections using a game-theoretic modeling framework called statistical teleodynamics. The competition causes connection values (weights) and parameters representing the neuronal behavior of neurons in the network to move (during multiple iterations at which the various adjustable parameters of the network get adjusted) to a state of arbitrage equilibrium (which corresponds a final state of a fully trained network). At arbitrage equilibrium, the connection weights and the neuronal iota are, in some embodiments, distributed lognormally.

This microstructure is independent of the architecture or the application. As discussed above in relation to FIG. 1, this behavior can be used by procedures/algorithms and hardware (processor-based, special-purpose, etc.) to reduce the time, data, and computational resources required to train large deep neural networks effectively. A neural network is a learning engine that has been optimally designed or evolved to make accurate predictions robustly under resource constraints. Therefore, its microstructure reflects the benefit-cost trade-offs made in its optimally robust design. By taking a game-theoretic perspective, the proposed approaches can account for the benefit-cost trade-offs. The proposed approaches can, as a result, maximize the potential in statistical teleodynamics to reach arbitrage equilibrium. Although, typically, active matter systems, such as neural networks, are often characterized as nonequilibrium or out-of-equilibrium systems, under the proposed approaches the network is characterized as a being organizing to reach an arbitrage equilibrium. As noted, the proposed approaches can use an entropy term (whether S_{w} or S_{N}). This built-in entropy term handles regularization right from the beginning of the network training process. Maximizing the potential Φ is equivalent to maximizing entropy (S_{w} or S_{N}) under constraints expressed by ϕᵤ^{l} and ϕᵥ^{l} for max S_{w}, or by Σₗ₌₁^{L}Σ_{q=1}ⁿ[ηx_{q}^{l}U_{q}^{l}−ζx_{q}^{l}V_{q}^{l}] for max S_{N}. Under the proposed approaches, all agents continuously strive to increase their individual effective utility by exploring all opportunities.

An important feature of the maximum entropy approach, expressed by the lognormal distribution at the arbitrage equilibrium, is that the effective utilities of all the connections are equal. Similarly, the arbitrage equilibrium of neurons shows that their effective utilities are also equal. These invariance-like properties reflect a deep sense of symmetry, harmony, and fairness in optimal network design.

As discussed, there are two local competitions that are happening simultaneously in every layer, one between the connections and the other between the neurons. Both reach their own arbitrage equilibrium when Φ_{w} and Φ_{N} are maximized, respectively. These arbitrage equilibria result in the emergence of two different lognormal distributions, one for connection weights and the other for neuronal iota.

In summary, the present disclosure presents a new framework of learning in large deep neural networks, which is formulated as a competition between neurons and between connections using a game-theoretic modeling framework called statistical teleodynamics. Such a competition will result in an arbitrage equilibrium, which is the final state of a fully trained network. At arbitrage equilibrium the connection weights and the neuronal iota are distributed lognormally. This microstructure is independent of the architecture or the application domain. This ideal network is referred to as the Jaynes Machine. These predictions are supported by empirical evidence from artificial neural networks. These results can be used to develop custom training algorithms and special-purpose hardware to reduce the time, data, and computational resources required to train large deep neural networks effectively.

As noted, concepts leveraged by the proposed approaches include the utility (benefit), the disutility (cost), and the effective utility (benefit-cost) of agents (neurons and connections), competition between agents, and the game potential (fairness in the assignment of effective utility) of the entire network. These model the information processing activities of neurons and connections in the network towards the minimization of the error or loss function.

As noted, an iotum Zᵢ^{l} is identified as an important fundamental quantity of information processing performed by a neuron to minimize the error function. The computational benefits and costs of neurons depend on this key quantity. It is similar to the interaction energy in physicochemical systems.

A neural network is a prediction engine that has been optimally designed or evolved to perform a function under resource constraints. Therefore, its microstructure reflects the benefit-cost trade-offs made in its optimally robust design. By taking a game-theoretic perspective, the benefit-cost trade-offs can be accounted for.

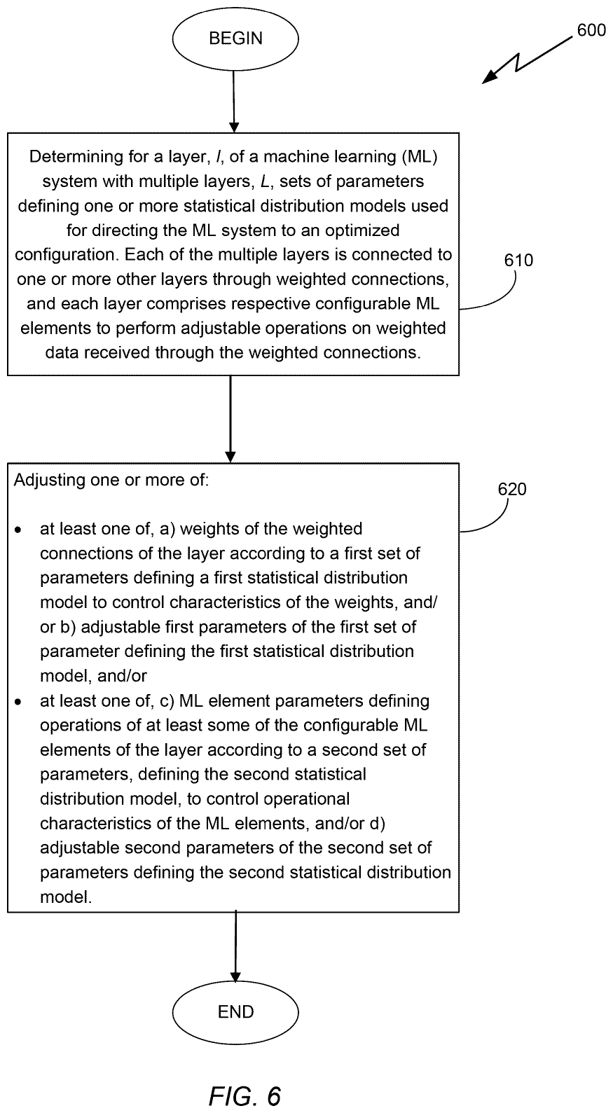

Thus, with reference to FIG. 6, a flowchart of an example procedure 600 for configuring a machine learning system is shown. The procedure 600 includes determining 610, for a layer, l, of the machine learning (ML) system with multiple layers, L, sets of parameters defining one or more statistical distribution models used for directing the ML system to an optimized configuration. Each of the multiple layers is connected to one or more other layers through weighted connections, and each layer comprises respective configurable ML elements to perform adjustable operations on weighted data received through the weighted connections. The procedure 600 further includes adjusting 620 one or more of, for example,
at least one of, a) weights of the weighted connections of the layer according to a first set of parameters defining a first statistical distribution model to control characteristics of the weights, and/or b) adjustable first parameters of the first set of parameters defining the first statistical distribution model; and/or
at least one of: c) ML element parameters defining operations of at least some of the configurable ML elements of the layer according to a second set of parameters, defining a second statistical distribution model, to control operational characteristics of the ML elements, and/or d) adjustable second parameters of the second set of parameters defining the second statistical distribution model.

In some embodiments, the ML system is a neural network system, and the first statistical distribution model is a first lognormal distribution defined at least by parameters μ_{l,w}, and σ_{l,w}, where μ_{l,w} is a mean parameter associated with the first lognormal statistical distribution characterizing the weights of the layer, and σ_{l,w} is a standard deviation parameter associated with the first lognormal statistical distribution. It is noted that other typers of ML systems may be used, and that other statistical distributions may be used (instead of a lognormal distribution) in order to control various behaviors of the ML system, or achieve certain objectives (e.g., optimize the network in some other manner different from the optimization that is achieved by a lognormal distribution as discussed herein).

In various examples, adjusting the weights of the weighted connections for the layer can include iteratively adjusting, according to an optimization process performed during an initial optimization period, one or more of the parameters μ_{l,w}, and σ_{l,w} to cause adjustment of the weighted connections to optimize performance of the network, and iteratively adjusting, during a second optimization period subsequent to the initial optimization period, one or more of the weights of the weighted connections of the layer to optimize the performance of the network.

That is, in such embodiments, the optimization process (e.g., one that may be implemented using a gradient descent process, to minimize the error between the output produced by the ML system in response input training samples, and ground truth data associated with the input training samples) may be such that during an initial stage of the process, its parameters defining a lognormal characteristics that are adjusted. Consequently, adjustment of the lognormal distribution can be used to control parameters of the ML system to change them so that parameters of the ML system conform to the adjusted lognormal distribution. Then, at a second stage, after the ML system parameters have been sufficiently adjusted so they have a distribution conforming to, for example, the most recently adjusted lognormal distribution performed during the initial period.

Thus, in some examples, iteratively adjusting, during the initial optimization period, the one or more of the parameters μ_{l,w}, and σ_{l,w} can further include adjusting the one or more weights of the weighted connections during the initial optimization period to fit an adjusted first statistical distribution model derived from the adjusted one or more of the parameters μ_{l,w}, and σ_{l,w}.

Iteratively adjusting the weights of the weighted connections during the second optimization period can include iteratively adjusting the one or more weights of the weighted connections during the second optimization period, using the optimization process to minimize an error function defined for the optimization process, subject to at least one constraint that the weights of the weighted connections of the layer approximate a particular first statistical distribution process derived from fixed values of the one or more of the parameters μ_{l,w}, and σ_{l,w}.

In some embodiments, adjusting the weights of the weighted connections for the layer can include initializing the weights of the weighted connections for the layer according to initial parameter values defining the first statistical distribution model for the layer.

Configuring the ML system also includes configuring parameters that control operation of ML elements (such as neurons). Accordingly, in various embodiments, the ML system may be a neural network system, with the ML elements including neural network neurons, and with the second statistical distribution model being a second lognormal distribution defined at least by parameters μ_{l,N}, and σ_{l,N}, where μ_{l,N} is a mean parameter associated with the second lognormal statistical distribution representing characteristics of outputs produced by the neurons in the layer, and σ_{l,N} is a standard deviation parameter associated with the second lognormal statistical distribution.

The parameters defining the operations of the neurons can include neuron parameters controlling the output produced by the neurons, with the neuron parameters controlling one or more operations, including, for example, summing the weighted inputs respectively received at each of the neurons, biasing the resultant sum to produce a resultant biased value by the each of the neurons, and/or applying an activation function to the resultant biased value produced by the each of the neurons. The activation function used by the each of the neurons may include a rectified linear unit (ReLU)-based function.

Adjusting at least one of the ML element parameters and the adjustable second parameters for the second statistical distribution model can include at least one of, for example, iteratively adjusting, according to an optimization process, one or more of the parameters μ_{l,N}, and σ_{l,N} associated with the second lognormal distribution model to cause adjustment of the neuron parameters to optimize performance of the network, and/or iteratively adjusting respective neuron parameters for one or more of the neurons in the layer to optimize the performance of the network.

In various examples, iteratively adjusting the respective neuron parameters can include iteratively adjusting the respective neuron parameters for one or more of the neurons using the optimization process to minimize an error function defined for the optimization process, subject to at least one constrains that outputs of the neurons in the layer approximate a particular second lognormal distribution model corresponding to fixed values of at least the parameters μl,N, and σl,N.

The network configuration procedure may be facilitated by assigning the weighted connections and/or the ML elements (neuron parameters) to bins (e.g., with the bibs corresponding to particular values or sub-ranges of values). The optimization (adjustment) process can then be applied (or otherwise use) the bins to simplify the optimization process. Thus, in some examples, the procedure 600 may further include assigning the one or more of, for example, the weights, the ML parameters, the adjustable first parameters, and/or the adjustable second parameters, to bins. In such examples, adjusting the one or more of the weights, the ML parameters, the adjustable first parameters, and/or the adjustable second parameters can include adjusting the one or more of the weights, the ML parameters, the adjustable first parameters, and/or the adjustable second parameters according to the assigned bins.

Performing the various techniques and operations described herein may be facilitated by a controller device(s) (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, efficient construction and implementation of a machine learning system. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

In implementations based on learning machines, different types of learning architectures, configurations, and/or implementation approaches may be used. Examples of learning machines include neural networks, including convolutional neural network (CNN), feed-forward neural networks, recurrent neural networks (RNN), transformer-based networks, etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc. Further examples of learning architectures that may be used to implement the framework described herein include language models architectures, large language model (LLM) learning architectures, auto-regressive learning approaches, etc. In some embodiments, encoder-only architectures, decoder-only architectures, encoder-decoder architecture may also be used in implementations of the framework described herein.

The neural networks (and other network configurations and implementations for realizing the various procedures and operations described herein) can be implemented on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's, which can be programmed according to, for example, a CUDA C platform), and may also include special purpose logic circuitry, e.g., an FPGA (field programmable gate array), an ASIC (application-specific integrated circuit), a DSP processor, an accelerated processing unit (APU), an application processor, customized dedicated circuity, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc.

The various learning processes implemented through use of the neural networks described herein may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, PyTorch, JAX, and other machine learning frameworks.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus, and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for configuring a machine learning system, the method comprising:
determining for a layer, l, of the machine learning (ML) system with multiple layers, L, sets of parameters defining one or more statistical distribution models used for directing the ML system to an optimized configuration, wherein each of the multiple layers is connected to one or more other layers through weighted connections, and wherein each layer comprises respective configurable ML elements to perform adjustable operations on weighted data received through the weighted connections; and
adjusting one or more of:
at least one of: a) weights of the weighted connections of the layer according to a first set of parameters defining a first statistical distribution model to control characteristics of the weights, and b) adjustable first parameters of the first set of parameters defining the first statistical distribution model; or
at least one of: c) ML element parameters defining operations of at least some of the configurable ML elements of the layer according to a second set of parameters, defining a second statistical distribution model, to control operational characteristics of the ML elements, and d) adjustable second parameters of the second set of parameters defining the second statistical distribution model.

2. The method of claim 1, wherein the ML system is a neural network system, and wherein the first statistical distribution model is a first lognormal distribution defined at least by parameters μ_{l,w}, and σ_{l,w}, where μ_{l,w} is a mean parameter associated with the first lognormal statistical distribution characterizing the weights of the layer, and σ_{l,w} is a standard deviation parameter associated with the first lognormal statistical distribution.

3. The method of claim 2, wherein adjusting the weights of the weighted connections for the layer comprises:
iteratively adjusting, according to an optimization process performed during an initial optimization period, one or more of the parameters μ_{l,w}, and σ_{l,w} to cause adjustment of the weighted connections to optimize performance of the network; and
iteratively adjusting, during a second optimization period subsequent to the initial optimization period, one or more of the weights of the weighted connections of the layer to optimize the performance of the network.

4. The method of claim 3, wherein iteratively adjusting, during the initial optimization period, the one or more of the parameters μ_{l,w}, and σ_{l,w} further comprises:
adjusting the one or more weights of the weighted connections during the initial optimization period to fit an adjusted first statistical distribution model derived from the adjusted one or more of the parameters μ_{l,w}, and σ_{l,w}.

5. The method of claim 3, wherein iteratively adjusting the weights of the weighted connections during the second optimization period comprises:
iteratively adjusting the one or more weights of the weighted connections during the second optimization period, using the optimization process to minimize an error function defined for the optimization process, subject to at least one constraint that the weights of the weighted connections of the layer approximate a particular first statistical distribution process derived from fixed values of the one or more of the parameters μ_{l,w}, and σ_{l,w}.

6. The method of claim 1, wherein adjusting the weights of the weighted connections for the layer comprises:
initializing the weights of the weighted connections for the layer according to initial parameter values defining the first statistical distribution model for the layer.

7. The method of claim 1, wherein the ML system is a neural network system, wherein the ML elements comprise neural network neurons, and wherein the second statistical distribution model is a second lognormal distribution defined at least by parameters μ_{l,N}, and σ_{l,N}, where μ_{l,N} is a mean parameter associated with the second lognormal statistical distribution representing characteristics of outputs produced by the neurons in the layer, and σ_{l,N} is a standard deviation parameter associated with the second lognormal statistical distribution.

8. The method of claim 7, wherein the parameters defining the operations of the neurons comprise neuron parameters to control the output produced by the neurons, with the neuron parameters controlling one or more operations including summing the weighted inputs respectively received at each of the neurons, biasing the resultant sum to produce a resultant biased value by the each of the neurons, and applying an activation function to the resultant biased value produced by the each of the neurons.

9. The method of claim 8, wherein the activation function used by the each of the neurons comprises a rectified linear unit (ReLU)-based function.

10. The method of claim 8, wherein adjusting at least one of the ML element parameters and the adjustable second parameters for the second statistical distribution model comprises at least one of:
iteratively adjusting, according to an optimization process, one or more of the parameters μ_{l,N}, and σ_{l,N} associated with the second lognormal distribution model to cause adjustment of the neuron parameters to optimize performance of the network; and
iteratively adjusting respective neuron parameters for one or more of the neurons in the layer to optimize the performance of the network.

11. The method of claim 10, wherein iteratively adjusting the respective neuron parameters comprises:
iteratively adjusting the respective neuron parameters for one or more of the neurons using the optimization process to minimize an error function defined for the optimization process, subject to at least one constraint that outputs of the neurons in the layer approximate a particular second lognormal distribution model corresponding to fixed values of at least the parameters μ_{l,N}, and σ_{l,N}.

12. The method of claim 1, further comprising:
assigning the one or more of the weights, the ML parameters, the adjustable first parameters, and/or the adjustable second parameters, to bins;
wherein adjusting the one or more of the weights, the ML parameters, the adjustable first parameters, and/or the adjustable second parameters comprises:
adjusting the one or more of the weights, the ML parameters, the adjustable first parameters, and/or the adjustable second parameters according to the assigned bins.

13. A machine learning (ML) system comprising:
one or more memory storage devices; and
one or more processor-based controllers in electrical communication with the one or more memory storage devices, the one or more processor-based controllers configured to:
determine for a layer, l, of the ML system with multiple layers, L, sets of parameters defining one or more statistical distribution models used for directing the ML system to an optimized configuration, wherein each of the multiple layers is connected to one or more other layers through weighted connections, and wherein each layer comprises respective configurable ML elements to perform adjustable operations on weighted data received through the weighted connections; and
adjust one or more of:
at least one of: a) weights of the weighted connections of the layer according to a first set of parameters defining a first statistical distribution model to control characteristics of the weights, and b) adjustable first parameters of the first set of parameters defining the first statistical distribution model; or
at least one of: c) ML element parameters defining operations of at least some of the configurable ML elements of the layer according to a second set of parameters, defining a second statistical distribution model, to control operational characteristics of the ML elements, and d) adjustable second parameters, of the second set of parameters defining the second statistical distribution model.

14. The system of claim 13, wherein the ML system is a neural network system, and wherein the first statistical distribution model is a first lognormal distribution defined at least by parameters μ_{l,w}, and σ_{l,w}, where μ_{l,w} is a mean parameter associated with the first lognormal statistical distribution characterizing the weights of the layer, and σ_{l,w} is a standard deviation parameter associated with the first lognormal statistical distribution.

15. The system of claim 14, wherein the one or more processor-based controllers configured to adjust the weights of the weighted connections for the layer are configured to:
iteratively adjust, according to an optimization process performed during an initial optimization period, one or more of the parameters μ_{l,w}, and σ_{l,w} to cause adjustment of the weighted connections to optimize performance of the network; and
iteratively adjust, during a second optimization period subsequent to the initial optimization period, one or more of the weights of the weighted connections of the layer to optimize the performance of the network.

16. The system of claim 15, wherein the one or more processor-based controllers configured to iteratively adjust, during the initial optimization period, the one or more of the parameters μ_{l,w}, and σ_{l,w} are further configured to:
adjust the one or more weights of the weighted connections during the initial optimization period to fit an adjusted first statistical distribution model derived from the adjusted one or more of the parameters μ_{l,w}, and σ_{l,w}.

17. The system of claim 13, wherein the ML system is a neural network system, wherein the ML elements comprise neural network neurons, and wherein the second statistical distribution model is a second lognormal distribution defined at least by parameters μ_{l,N}, and σ_{l,N}, where μ_{l,N} is a mean parameter associated with the second lognormal statistical distribution representing characteristics of outputs produced by the neurons in the layer, and σ_{l,N} is a standard deviation parameter associated with the second lognormal statistical distribution for the neurons in the layer.

18. The system of claim 17, wherein the parameters defining the operations of the neurons comprise neuron parameters to control the output produced by the neurons, with the neuron parameters controlling one or more operations including summing the weighted inputs respectively received at each of the neurons, biasing the resultant sum to produce a resultant biased value by the each of the neurons, and applying an activation function to the resultant biased value produced by the each of the neurons.

19. The method of claim 18, wherein the one or more processors configured to adjust at least one of the ML element parameters and the adjustable second parameters for the second statistical distribution model are configured to perform at least one of:
iteratively adjust, according to an optimization process, one or more of the parameters μ_{l,N}, and σ_{l,N} associated with the second lognormal distribution model to cause adjustment of the neuron parameters to optimize performance of the network; or
iteratively adjust respective neuron parameters for one or more of the neurons in the layer to optimize the performance of the network.

20. Non-transitory computer readable media comprising computer instructions executable on a processor-based device to:
determine for a layer, l, of a machine learning (ML) system with multiple layers, L, sets of parameters defining one or more statistical distribution models used for directing the ML system to an optimized configuration, wherein each of the multiple layers is connected to one or more other layers through weighted connections, and wherein each layer comprises respective configurable ML elements to perform adjustable operations on weighted data received through the weighted connections; and
adjust one or more of:
at least one of: a) weights of the weighted connections of the layer according to a first set of parameters defining a first statistical distribution model to control characteristics of the weights, and b) adjustable first parameters of the first set of parameters defining the first statistical distribution model; or
at least one of: c) ML element parameters defining operations of at least some of the configurable ML elements of the layer according to a second set of parameters, defining a second statistical distribution model, to control operational characteristics of the ML elements, and d) adjustable second parameters of the second set of parameters defining the second statistical distribution model.
